(19) United States
(12) Patent Application Publication
(10) Pub. No.: US 2013/0172415 A1
(43) Pub. Date: Jul. 4, 2013

(54) TRICLOSAN-FREE ANTIBACTERIAL SOAP

(71) Applicants: Yvan Vermeulen, Wijk Aan Zee (NL); Margaret E. Bissell, Winchester, VA (US); John Van Cassel, Leiden (NL)

(72) Inventors: Yvan Vermeulen, Wijk Aan Zee (NL); Margaret E. Bissell, Winchester, VA (US); John Van Cassel, Leiden (NL)

(73) Assignee: RUBBERMAID COMMERCIAL PRODUCTS/US, Winchester, VA (US)

(21) Appl. No.: 13/340,551

(22) Filed: Dec. 29, 2011

(51) Int. Cl. A01N 37/36; A01P 1/00

(52) U.S. Cl. 514/557

(57) ABSTRACT

Disclosed herein is an antibacterial cleansing composition. The cleansing composition is free of triclosan and comprises lactic acid/lactate and ethyl alcohol. Lactic acid/lactate is present in the composition in an amount of about 5 weight percent (wt %) to about 15 wt %, based on the total weight of the composition. Ethyl alcohol is present in an amount of about 1 wt % to about 20 wt %, based on the total weight of the composition. The pH of the composition is about 4 to about 5. The triclosan-free cleansing composition according to the invention has broad spectrum antibacterial activity that equals or even surpasses comparable formulations containing triclosan.

### FIELD OF THE INVENTION

The invention is directed to an antibacterial liquid cleansing composition suitable for use in a personal care product. The antibacterial liquid cleansing composition according to the invention comprises lactic acid/lactate and ethyl alcohol and does not contain triclosan. The antibacterial liquid cleansing composition according to the invention demonstrates broad-spectrum antibacterial activity and is equally effective at eliminating bacterial contamination as comparable formulations containing triclosan.

### BACKGROUND OF THE INVENTION

Antimicrobial liquid cleansing products such as antibacterial soaps and hand sanitizers have risen in popularity over the past decade and are now a billion-dollar industry. Such antibacterial cleansers were once largely confined to medical settings. Virulent outbreaks of bacterial infections including Escherichia coli and Listeria monocytogenes among the general population in recent years, however, have fueled consumer demand for personal care products that eliminate skin microorganisms. Such consumer demands are reflected in the market place. For example, a recent survey of soap products currently on the market determined that about 75% of liquid soaps contain antibacterial agents.

The antibacterial compound most frequently found in consumer products is 5-chloro-2-(2,4-dichlorophenoxy)phenol, more commonly known as triclosan. Triclosan has been in use for decades and is present in almost half of the liquid soaps currently on the market. Triclosan can also be found in hundreds of other product categories, including toothpaste, clothing, and toys. Triclosan has proven broad-spectrum efficacy against most Gram-positive and Gram-negative bacteria. The compound exerts bactericidal activity through multiple mechanisms, including the inhibition of fatty acid synthesis in bacterial cells. In personal care products, triclosan is generally used in an amount of about 0.1 weight percent (wt %) to about 0.5 wt %, based on the total weight of the composition, in order to provide sufficient antimicrobial activity. For example, a commercially available antibacterial cleansing composition containing 0.5 wt % triclosan and 5.4 wt % lactic acid/lactate in a liquid soap base comprising water, about 4 wt % sodium laureth sulfate, 4 wt % sodium cumenesulfonate, 10 wt % propylene glycol, and 1 wt % cocamidopropyl betaine and having a pH of about 4.5 is known in the art. Other antibacterial cleansing compositions known in the art having pH values between about 4.2 and 4.5 comprise about 0.3 wt % triclosan and 10 wt % lactic acid/lactate as active antimicrobial agents in a similar liquid soap base further including about 4.5 wt % ethyl alcohol.

The safety of triclosan is controversial, however. Some scientists have warned that overuse of the compound could cause resistant strains of bacteria to develop. There is also concern over the effects of triclosan on humans. The chemical has been found to accumulate within the body, and recent studies have linked triclosan to the development of allergies and disruption of hormone regulation. Because of the potential safety issues associated with triclosan, some consumer groups have called for a ban on its use. Indeed, the hazards of triclosan are reflected in its registration as a pesticide with the Environmental Protection Agency. In view of the aforementioned health concerns, both the Food and Drug Administration and Environmental Protection Agency are currently re-evaluating the safety of triclosan in consumer products. However, despite concerns over triclosan's safety, its use remains widespread due to the compound's superior antibacterial properties. With the safety of triclosan in question and an unwaning threat of harmful bacteria, however, there exists a need for antibacterial consumer products that are triclosan-free, but still effective at killing microorganisms.

### SUMMARY OF THE INVENTION

The invention provides an antibacterial liquid cleansing composition that is free of triclosan and comprises lactic acid/lactate and ethyl alcohol. Lactic acid/lactate is typically present in the composition in an amount of about 5 wt % to about 15 wt %. Ethyl alcohol is typically present in an amount of about 1 wt % to about 20 wt %. The pH of the composition is generally between about 4 and about 5. The triclosan-free antibacterial liquid cleansing composition of the invention has broad-spectrum antimicrobial activity against both Gram-positive and Gram-negative bacteria.

The invention also provides a method of sanitizing comprising applying an antibacterial liquid cleansing composition that is free of triclosan and comprises lactic acid/lactate and ethyl alcohol to a surface as to eliminate microorganisms.

### DETAILED DESCRIPTION OF THE INVENTION

The invention provides a liquid cleansing composition comprising lactic acid/lactate and ethyl alcohol that is free of triclosan and surprisingly exhibits broad-spectrum antimicrobial activity against both Gram-negative and Gram-positive bacteria.

Surprisingly, the liquid cleansing composition according to the invention comprising lactic acid/lactate and a relatively low concentration of ethyl alcohol, without any additional conventional antimicrobial agents such as triclosan, exhibits potent bactericidal properties. Advantageously, the liquid cleansing composition can reduce bacterial populations by at least 99.999% after a brief exposure period of as little as 15 seconds.

Even more surprisingly, the triclosan-free liquid cleansing composition according to the invention demonstrates antibacterial properties that are at least equivalent and in some instances even superior to comparable formulations containing triclosan as an active antimicrobial ingredient. For example, the liquid cleansing composition according to the invention comprising lactic acid/lactate and ethyl alcohol achieved a 99.9% reduction in Escherichia coli after a 15-second contact time. Under the same testing conditions, a commercially available liquid cleansing composition comprising lactic acid/lactate and triclosan only achieved a 60% reduction in the bacteria (the comparative antibacterial cleansing composition containing 0.5 wt % triclosan and 5.4 wt % lactic acid/lactate in a liquid soap base comprising water, about 4 wt % sodium laureth sulfate, 4 wt % sodium cumenesulfonate, 10 wt % propylene glycol, and 1 wt % cocamidopropyl betaine and having a pH of about 4.5, as described above in the background section). The surprisingly superior efficacy of the antibacterial cleansing composition according to the invention compared to such a triclosan-containing formulation is particularly unexpected in view of the Environmental Protection Agency's classification of lactic acid and ethyl alcohol as inert ingredients (in stark contrast to the agency's classification of triclosan as a pesticide).

Unexpectedly, the addition of triclosan to a liquid cleansing composition otherwise in accordance with the invention does not increase the antibacterial efficacy of the formulation. Considering triclosan's established reputation as a potent antimicrobial agent, its inclusion in a liquid cleansing composition would be expected to enhance the product's antibacterial effects, however, the liquid cleansing composition according to the invention exhibits maximal bactericidal properties independent of triclosan. That is, a liquid cleansing composition according to the invention comprising lactic acid/lactate and ethyl alcohol that is free of triclosan surprisingly and advantageously achieves at least equivalent reductions in bacterial populations as a composition comprising triclosan, lactic acid/lactate, and ethyl alcohol. For certain bacteria, such as Staphylococcus aureus, the triclosan-free formulation surprisingly surpasses the triclosan-containing product in efficacy. Consequently, the liquid cleansing composition according to the invention advantageously provides a safe alternative to products containing controversial antimicrobial agents such as triclosan, without sacrificing antibacterial efficacy.

Lactic acid and its counter anion lactate can be derived from milk. Lactic acid is most commonly used in personal care products as an exfoliant, not for any antibacterial properties. It is well known that lactic acid exists in equilibrium with its counter anion lactate and that the relative concentrations of these two species depends on the pH of the system. Hence, the amount of lactic acid initially added to a composition will not directly correspond to the amount of lactic acid present in the composition after equilibrium is achieved, particularly when the pH of the composition differs from the pH of 100% lactic acid. Lactic acid/lactate is generally present in the liquid cleansing compositions according to the invention in an amount of about 5 wt % to about 15 wt %, about 9 wt % to about 12 wt %, and/or about 10 wt % to about 11 wt %, for example, about 10 wt %, based on the total weight of the composition.

Ethyl alcohol is a known bactericide, however, a high concentration of ethyl alcohol is typically needed to confer antimicrobial properties to a product formulation. For example, ethyl alcohol in a hand sanitizer gel is typically present in an amount of at least 50 wt %, most frequently between about 60 wt. % and about 90 wt %, to provide sufficient antimicrobial activity and thus function as an active antimicrobial ingredient. In contrast, ethyl alcohol is generally present in the invention an amount of about 1 wt % to about 20 wt %, about 3 wt % to about 10 wt %, and/or about 4 wt % to about 6 wt %, for example, about 5 wt %.

The pH of the liquid cleansing composition according to the invention is generally between about 4 to about 5, about 4.2 to about 4.8, about 4.3 to about 4.7, for example, about 4.5.

The cleansing composition according to the invention typically further contains additional components including, but not limited to, solvents, surfactants, and pH adjusting agents. In some embodiments, the invention may also further include additional components such as viscosity enhancers, skin conditioning agents, and preservatives.

In the liquid cleansing composition according to the invention, the lactic acid/lactate and ethyl alcohol are typically dissolved in a solvent. The total amount of solvent in the liquid cleansing composition according to the invention is typically between about 10 wt % to about 85 wt % and/or between about 50 wt % to about 80 wt %, for example, about 70 wt %. The solvent may be comprised of, for example, a combination of water and a hydric solvent which is different from ethyl alcohol. Examples of suitable hydric solvents include, but are not limited to, hydroxyl-containing compounds such as methanol, ethylene glycol, propylene glycol, glycerol, diethylene glycol, dipropylene glycol, tripropylene glycol, hexylene glycol, butylene glycol, and sorbitol. Additional solvents that are contemplated for use with the present invention and may be substituted for those disclosed herein are described in the CTFA Cosmetic Ingredient Handbook, First Edition, Cosmetic, Toiletry, and Fragrance Association, Washington D.C., (1988) at pages 85-86, (the CTFA Handbook“), which are hereby incorporated herein by reference.

One or more surfactants is generally present in the liquid cleansing composition according to the invention. The surfactant(s) can be added to the liquid cleansing composition according to the invention to improve cleansing power and foam production. The total amount of surfactant in the liquid cleansing composition according to the invention is typically between about 2 wt % to about 20 wt % and/or about 5 wt % to about 15 wt %, for example, about 6 wt %. Non-limiting examples of suitable surfactants include but are not limited to sodium laureth sulfate and ammonium lauryl sulfate. Foaming agent surfactants such as cocamidopropyl betaine and shea butteramidopropyl betaine may also be used in the invention. Another type of surfactant that may be included in the composition is a hydrotrope. A hydrotrope enhances the water solubility of the other components in the formulation. Representative hydrotropes include, but are not limited to, alkyl aryl sulfonate compounds including sodium cumenesulfonate, ammonium cumene sulfonate, ammonium xylene sulfonate, potassium tolulene sulfonate, and xylene sulfonic acid. Additional surfactants suitable for use with the invention are disclosed in the CTFA Handbook at pages 87-97, which are hereby incorporated herein by reference.

In one embodiment, the liquid cleansing composition further comprises a pH adjusting agent. The pH adjusting agent may be added in an amount to achieve a pH within the range of about 4 to about 5, about 4.2 to about 4.8, about 4.3 to about 4.7, for example, about 4.5, for the liquid cleansing composition according to the invention. The pH adjusting agent may be added to partially neutralize lactic acid (i.e., convert the lactic acid to its counter anion lactate) present in the liquid cleansing composition. The pKa of lactic acid is 3.79, so since a liquid cleansing composition according to the invention has a pH higher than the pKa of lactic acid, more lactate is present than lactic acid. The higher concentration of lactate relative to lactic acid generally minimizes skin irritation while still presenting excellent antimicrobial activity. The proximity of the slightly acidic pH of the invention to the normal pH of skin also serves to reduce damage to the epidermis. Suitable pH adjusting agents include, but are not limited to, strong bases such as sodium hydroxide and potassium hydroxide. Buffering agents such as sodium acetate, sodium citrate, and sodium lactate may also serve as pH adjusting agents in the invention, again provided that the resulting pH of the liquid cleansing composition according to the invention is within the described range. More examples of pH adjusting agents suitable for use in the liquid cleansing composition according to the invention are described in the CTFA handbook at page 77, which is hereby incorporated herein by reference.

Additives are frequently included in cleansing formulations to improve the aesthetic properties of a product. For example, a viscosity enhancing agent may be added to the invention to provide the antibacterial composition with a desired texture and feel. A viscosity enhancing agent may be present in an amount less than about 1 wt %, for example, about 0.9 wt %. Suitable viscosity enhancing agents include, for example, hydroxypropyl guar, seaweed extracts, synthetically modified versions of cellulose and/or starch, propylene glycol alginate, carboxymethyl locust bean gum, carboxymethyl guar, xanthan gum, carboxymethylcellulose, hydroxyethylecellulose, sodium alginate and other salts of alginic acid, carrageenan, gum arabic, gum karaya, gum tragacanth, gum ghatti, guar gum, locust bean gum, and other polysaccharides. Other examples of viscosity enhancing agents contemplated for use in the liquid cleansing composition according to the invention are disclosed in the CTFA handbook at pages 99-100, which are hereby incorporated herein by reference.

Optionally, preservatives may be present in the invention. The total concentration of preservatives in the composition is less than about 0.1 wt %, for example, about 0.09 wt %. Examples of suitable preservatives include benzyl alcohol, methylchloroisothiazolinone and methylisothiaziolinone. One skilled in the art would understand that other preservatives, including but not limited to those based on organic acids such as benzoic acid and potassium sorbate may also be used in the liquid cleansing composition according to the invention. Others examples of preservatives contemplated for use in the liquid cleansing composition according to the invention are disclosed in the CTFA handbook at page 78, which is hereby incorporated herein by reference.

Skin conditioning agents are optionally present in the formulation. Skin conditioning agents improve cosmetic benefits and appeal to consumers. A non-limiting example of a suitable skin conditioning agent is a vitamin derivative such as disodium lauriminodipropionate tocopheryl phosphates. Additional examples of skin conditioning agents contemplated for use in the liquid cleansing composition according to the invention are described in the CTFA handbook at pages 80-84, which are hereby incorporated herein by reference. Other ingredients known in the art to improve the commercial appeal of the product may be present in the invention. Examples include humectants, fragrances, dyes, and antioxidants, all of which are well-known and disclosed in the CTFA handbook at pages 55, 63, 69-70, and 75, which are hereby incorporated herein by reference.

A liquid cleansing composition according to the invention may be applied to a palm of a hand to eliminate microorganisms. A cleansing composition according to the invention may be applied in a similar fashion to additional areas of the body or other surfaces to reduce bacterial contamination.

In one embodiment, a liquid cleansing composition according to the invention is prepared by combining water, about 10 wt % lactic acid, about 5 wt % ethyl alcohol, 2 wt % sodium hydroxide (33% solution), and, optionally, propylene glycol, sodium cumenesulfonate, sodium laureth sulfate, cocamidopropyl betaine, hydroxypropyl guar, and 0.1 wt % or less of shea butteramidopropyl betaine, preservatives, and disodium lauriminodipropionate tocopheryl phosphates. In the following Examples, liquid cleansing compositions according to the invention were tested for antibacterial properties and compared to triclosan-containing liquid soaps currently sold on the world market. Surprisingly, the invention demonstrated broad-spectrum efficacy against Gram-positive bacteria such as Staphylococcus aureus and Gram-negative bacteria including Escherichia coli and Pseudomonas aeruginosa and passed industry standards for commercially acceptable bactericidal properties. Examples 1 and 2 demonstrate the bactericidal efficacy of the liquid cleansing invention comprising lactic acid/lactate and ethyl alcohol compared to similar compositions containing triclosan.

### EXAMPLE 1

Composition A, a triclosan-free cleansing composition according to the invention, was evaluated for antibacterial properties using an in-vitro time-kill method test. The composition of the triclosan-free cleansing composition according to the invention follows:

| | Trade Name | |
|---|---|---|
| Ingredient | (Supplier) | Weight % |
| Water | Deionized Water | 47.52 |
| Lactic Acid (90%) | PURAC ® HiPure 90 | 11.10 |
| | (PURAC) | |
| Propylene Glycol | Propylene Glycol USP | 9.80 |
| | (Jeen Int.) | |
| Ethyl Alcohol 96% | SDA 3C | 5.05 |
| Sodium Cumenesulfonate 40% | Stepanate SCS 40% | 10.0 |
| | (Stepan) | |
| Sodium Laureth Sulfate 70% | Steol CS-270 70% | 5.60 |
| | (Stepan) | |
| Sodium Hydroxide | Sodium Hydroxide | 6.50 |
| | 33% | |
| Cocamidopropyl Betaine, Glycerin | Jeeteric CAB-CL | 3.33 |
| | (Jeen Int.) | |
| Hydroxypropyl Guar | Guar 105 (Jova) | 0.90 |
| Methylchloroisothiazolinone, | Kathon CG (Dow) | 0.09 |
| Methylisothiazolinone | | |
| Disodium Lauriminodipropionate | Vital ET ® (ISP) | 0.01 |
| Tocopheryl Phosphate 10% | | |
| solution | | |
| Shea Butteramidopropyl Betaine | Lipex ® Shea Betaine | 0.10 |
| 10% solution | (AarhusKarlshamn) | |

The ability of Composition A to reduce bacterial populations of Escherichia coli and Staphylococcus aureus was tested. The reduction from the initial population for each species was calculated following exposure to the product for 15 seconds, 30 seconds, 1 minute, or 5 minutes. In this example, the cleansing composition according to the invention was evaluated at a concentration of 99 volume %. The same protocol was also used to evaluate Composition B, a triclosan-containing soap with a composition substantially identical to Composition A, except with the addition of 0.3 wt % triclosan. Composition A and Composition B both have a pH of about 4.5. The results of the studies are summarized below.

| | | | COMPOSITION A | COMPOSITION B |
|---|---|---|---|---|
| Microorganism | Exposure Time | | Log₁₀ Reduction | |
| Escherichia coli | 15 | seconds | 6.1271 | 6.1271 |
| (ATCC# 11229) | 30 | seconds | 6.1271 | 6.1271 |
| | 1 | minute | 6.1271 | 6.1271 |
| | 5 | minutes | 6.1271 | 6.1271 |
| Staphylococcus | 15 | seconds | 6.0934 | 5.0934 |
| aureus aureus | 30 | seconds | 6.0934 | 5.0934 |
| (ATCC# 6538) | 1 | minute | 6.0934 | 5.0934 |
| | 5 | minutes | 6.0934 | 5.0934 |

Surprisingly, Composition A in accordance with invention, surprisingly and unexpectedly exhibited more potent antibacterial properties than the corresponding triclosan-enriched product. The claimed invention reduced the populations of both bacterial species by more than 6.0 log (greater than 99.9999%) after all exposure times tested. In comparison, Composition B, the triclosan-containing product, reduced the Escherichia coli bacterial population by more than 6.0 log after all exposure times tested, however, the reduction in Staphylococcus aureus was less than 5.1 log.

### EXAMPLE 2

Composition A, the triclosan-free cleansing product according to the invention from Example 1, was evaluated for antibacterial properties using a quantitative suspension test performed according to the European standard EN1040 for evaluating basic bactericidal activity in chemical disinfectants and antiseptics. The ability of the composition according to the invention to reduce bacterial populations of Staphylococcus aureus and Pseudomonas aeruginosa was tested. In this example, the cleansing composition according to the invention was evaluated at a concentration of 80 volume %. The bacterial cells were incubated in a dilution of the test product in water for 15 seconds, 30 seconds, 1 minute, or 5 minutes. The test product was then neutralized using a solution of 3.0% Tween 80, 0.3% lecithin, 0.1% histidine, and 0.5% sodium thiosulfate in tryptone soybean broth. The reduction from the initial population for each species was calculated after plating. The same protocol was also used to evaluate Composition B, the formulation from Example 1 further containing 0.3 wt % triclosan, a known, conventional active antimicrobial ingredient. The results of the studies are summarized below.

| | | | COMPOSITION A | COMPOSITION B |
|---|---|---|---|---|
| Microorganism | Exposure Time | | Log₁₀ Reduction | |
| Pseudomonas | 15 | seconds | >5.55 | >5.55 |
| aeruginosa | 30 | seconds | >5.55 | >5.55 |
| (ATCC# 15442) | 1 | minute | >5.55 | >5.55 |
| | 5 | minutes | >5.55 | >5.55 |
| Staphylococcus | 15 | seconds | >5.55 | >5.55 |
| aureus aureus | 30 | seconds | >5.55 | >5.55 |
| (ATCC# 6538) | 1 | minute | >5.55 | >5.55 |
| | 5 | minutes | >5.55 | >5.55 |

Unexpectedly, Composition A, the triclosan-free composition, was equally effective at killing bacteria as Composition B, the triclosan-containing soap. In addition, the triclosan-free product caused a greater than 5.5 log reduction in the bacterial populations at all contact times tested, thereby meeting the EN1040 standard for basic bactericidal activity in a chemical disinfectant.

The foregoing Examples are provided to further illustrate the invention without being limiting. While particular embodiments of the present invention have been illustrated and described, it would be obvious to those skilled in the art that various other changes and modifications can be made without departing from the spirit and scope of the invention. It is therefore intended to cover in the claims all such changes and modifications that are within the scope of this invention.

The description and Examples establish that the combination of lactic acid/lactate and ethyl alcohol in cleansing compositions according to the invention surprisingly equals and in some instances even surpasses the antibacterial efficacy of comparable compositions further containing triclosan. Lactic acid/lactate and ethyl alcohol are compounds which are known to be safe, however, and thus the potent bactericidal effects of a composition comprising about 5 wt % to about 15 wt % lactic acid/lactate and about 1 wt % to about 20 wt % ethyl alcohol, with a pH of about 4 to about 5, were completely unexpected. As a result, the liquid cleansing compositions according to the invention offer the benefit of eliminating skin microorganisms while providing a safe alternative to comparable liquid cleansing compositions containing triclosan and other potentially harmful antimicrobial agents.

1. An antibacterial cleansing composition comprising:
about 5 weight percent (wt %) to about 15 wt % lactic acid/lactate;
about 1 wt % to about 20 wt % ethyl alcohol;
wherein the composition is free of triclosan, the pH of the composition is about 4 to about 5, and the composition has bactericidal activity against both Gram-positive and Gram-negative bacteria.

2. The composition of claim 1, wherein the lactic acid/lactate is present in an amount of about 9 wt % to about 12 wt %.

3. The composition of claim 2, wherein the lactic acid/lactate is present in an amount of about 10 wt %.

4. The composition of claim 1, wherein the ethyl alcohol is present in an amount of about 3 wt % to about 10 wt %.

5. The composition of claim 4, wherein the ethyl alcohol is present in an amount of about 5 wt %.

6. The composition of claim 1, wherein the pH of the composition is about 4.2 to about 4.8.

7. The composition of claim 6, wherein the pH of the composition is about 4.5.

8. The composition of claim 1, further comprising a solvent in an amount of about 10 wt % to about 85 wt %.

9. The composition of claim 7, wherein the solvent is in an amount of about 70 wt %.

10. The composition of claim 7, wherein the solvent is selected from the group consisting of water, propylene glycol, and combinations thereof.

11. The composition of claim 1, further comprising a surfactant in an amount of about 2 wt % to about 20 wt %.

12. (canceled)

13. The composition of claim 10, wherein the surfactant is selected from the group consisting of sodium cumenesulfonate, sodium laureth sulfate, cocamidopropyl betaine, shea butteramidopropyl betaine, and combinations thereof.

14. The composition of claim 1, further comprising a pH adjusting agent in an amount effective to achieve a pH within the range of about 4 to about 5.

15. The composition of claim 14, wherein the pH adjusting agent is present in an amount effective to achieve a pH of about 4.5.

16. The composition of claim 14, wherein the pH adjusting agent is sodium hydroxide.

17. The composition of claim 1, further comprising a viscosity enhancing agent in an amount less than about 1 wt %.

18. The composition of claim 17, wherein the viscosity enhancing agent is hydroxypropyl guar.

19. The composition of claim 1, further comprising a preservative in an amount less than about 0.1 wt %.

20. The composition of claim 1, further comprising a skin conditioning agent.

21. (canceled)

22. A method of sanitizing hands comprising applying a composition of 1 to a palm of a hand to eliminate skin microorganisms.
